(19) United States
(12) Patent Application Publication
(10) Pub. No.: US 2025/0153680 A1
(43) Pub. Date: May 15, 2025

(54) NETWORKABLE DUAL-MODE TRUCK TESTER

(71) Applicant: SCULLY SIGNAL COMPANY, Wilmington, MA (US)

(72) Inventors: Stephen P. Atwood, Webster, MA (US); Robert A. McGonagle, Prattville, AL (US); Robert R. Trottier, Andover, MA (US)

(21) Appl. No.: 18/507,256

(22) Filed: Nov. 13, 2023

(51) Int. Cl. B60R 25/102; B60R 25/10; B60R 25/20

(52) U.S. Cl. CPC B60R 25/102; B60R 25/20; B60R 2025/1016; B60Y 2200/146; B60Y 2304/00

(57) ABSTRACT

Portable devices and methods for testing a tanker truck safety and identification system. In one example, a portable tanker truck testing device includes a plurality of contact pins configured to couple with corresponding contact pads on the tanker truck safety and identification system, a memory, a display, a wireless communication interface configured to support communication of data via at least one network protocol, and a microprocessor. The microprocessor is configured to configured to run a program to test one or more components of the tanker truck safety and identification system, to display test results on the display, and to transmit, via the wireless communication interface, test results and information to a remote computing device.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

Controlling the safe and proper transfer of potentially hazardous fluids, such as flammable and/or toxic fluids, when loading transportation vehicles such as tanker trucks or other fluid transport vehicles is an important safety concern. Accordingly, various safety devices have been implemented on tanker trucks that prevent fluid transfer from a loading terminal to the truck if certain unsafe conditions surrounding the transfer exist. Some such safety devices include electronics for overfill detection, grounding and vehicle identification systems.

A tanker truck 100, as shown in FIG. 1A, has multiple fluid containment compartments 102. The number of compartments can vary from one tanker truck to another. For example, in the United States, tanker trucks can have any number of compartments from one to six with the typical configuration at four to five compartments, and in Europe, tanker trucks can have up to sixteen compartments. Each compartment 102 can be filled with a different type of fluid, allowing for the transport of a variety of fluid types in a single truckload. Further, each compartment can have a different capacity and fill level. Accordingly, to prevent overfilling of the compartments 102, an overfill sensor 104 is located in each compartment. In the example of FIG. 1A, the sensor 104 of each compartment 102 is connected to a connection socket 106. A pumping controller 108 is connected to the connection socket 106 via a plug 110. The controller 108 is therefore able to receive the signals from the various sensors on the truck (overfill, ground, etc.) and controls the filling of the tanker truck 100. When a hazardous condition is detected, such as when one of the overfill sensors 104 indicates that the fluid in its compartment has reached the threshold level, the controller 108 will halt the filling process.

In the Example of FIG. 1A, the sensors 104 are connected directly to the connection socket 106. In other examples, the tanker truck 100 includes a truck controller 112 that is connected between the connection socket 106 and the sensors 104, as shown in FIG. 1B, for example. In some examples, the truck controller 112 can perform various tasks, such as monitoring a wider array of sensors 104 including overfill and product retain sensors, for example. The truck controller 112 can further be programmed to operate valves mounted on the tanker truck 100. The truck controller 112 can interface to the pumping controller 108 through the connection socket 106. In some examples, the truck controller 112 mimics a sensor interface and signals “wet” or “dry” sensor status indicators to the pumping controller 108 through the connection socket 106 using the same electrical interface as do the sensors 104.

There are several types of sensors and various ways of connecting the sensors 104 to the connection socket 106 of the controller 108, either directly or via the truck controller 112. For example, 2-wire systems (in which each sensor 104 has two wires, a shared common ground and a signal wire independently connected to the connection socket) and 5-wire systems (in which each sensor has five wires and the sensors 104 are connected together in series in a “daisy chain”) are both commonly used sensor types. In some instances, a second checking mechanism that uses an identification module such as the T.I.M.® electronics module from Scully Signal Company of Wilmington, Mass., to assign a unique serial number to a vehicle is also provided. Once attached to a specific vehicle, the T.I.M. system associates a unique ID with the vehicle, referred to as a Truck ID (TID), that can be read by several different systems. The T.I.M. system and associated TID can be used to validate a vehicle's authorization to load in a manned or unmanned terminal and for verifying fluid type access.

The above-described onboard safety sensors and systems can prevent a truck from loading fluids if an issue is detected or from overfilling a compartment and creating a hazardous spill. Further, as a failsafe, in the event of failure of any of the safety systems installed on the truck, the truck can also be prevented from loading fluids. However, such failures may not be discovered until an attempt to load the truck is underway, which can result in significant wasted time. Accordingly, there is a need to be able to quickly and easily test the onboard safety equipment on tanker trucks and other types of trucks.

### SUMMARY

Aspects and embodiments are directed to truck tester systems and methods of operating them.

According to one embodiment, a dual-mode portable device for determining the status of a tanker truck safety and identification system comprises a plurality of contact pins configured to couple with corresponding contact pads on the connection socket of the tanker truck safety and identification system, a memory, a display, a wireless communication interface configured to support communication of data via at least one network protocol, and a microprocessor coupled to the plurality of contact pins, to the memory, and to the wireless communication interface. The microprocessor is configured to run a program to test one or more components of the tanker truck safety and identification system to determine the status of the tanker truck safety and identification system, in each of a first mode of operation and a second mode of operation of the dual-mode portable device, cause information regarding the status of the tanker truck safety and identification system to be displayed on the display and, upon completion of the program, store the information regarding the status of the tanker truck safety and identification in the memory, and in the second mode of operation of the dual-mode portable device, establish a connection with a remote device via the wireless communication interface, and transmit the information regarding the status of the tanker truck safety and identification to the remote device via the wireless communication system.

Another embodiment is directed to a portable device for determining a status of a tanker truck safety and identification system, the portable device comprising a plurality of contact pins configured to couple with corresponding contact pads on the tanker truck safety and identification, at least one of the contact pads being coupled to at least one sensor of the tanker truck safety and identification, a memory, a wireless communication interface configured to support communication of data via at least one network protocol, and a microprocessor coupled to the plurality of contact pins, to the memory, and to the wireless communication interface. The microprocessor is configured to establish a connection with a remote device via the wireless communication interface, run one or more programs to test each at least one sensor to determine the status of the tanker truck safety and identification system, during running of the one or more programs, transmit status indicators for each at least one sensor of the tanker truck safety and identification system to the remote device via the wireless communication interface, store information regarding the status of the tanker truck safety and identification system in the memory upon completion of the one or more programs, receive, via the wireless communication, a request from the remote device to transfer the information, and after receiving the request, transmit the information to the remote device via the wireless communication system.

According to another embodiment, a system for determining a status of a tanker truck safety and identification system comprises a portable testing device configured to be coupled to one or more components of the tanker truck safety and identification system. The portable testing device comprises a plurality of contact pins configured to couple with corresponding contact pads on the tanker truck safety and identification, a memory, a wireless communication interface configured to support communication of data via at least one network protocol, and a microprocessor coupled to the plurality of contact pins, to the memory, and to the wireless communication interface. The microprocessor is configured to run one or more programs to test the one or more components to determine the status of the tanker truck safety and identification system and to store information regarding the status of the tanker truck safety and identification system in the memory. The system further comprises a computing device configured to be communicatively coupled to the portable testing device via the wireless communication link established with the portable testing device via the wireless communication interface. The computing device is configured to run a control program to display, on the computing device and during running of the at least one program, results of the tests of the one or more components, and after completion of the at least one program, initiate transfer of the information regarding the status of the tanker truck safety and identification system from the memory of the portable testing device to the computing device.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, the same or similar components that are illustrated are represented by a like reference numeral. For purposes of clarity, every component may not be labeled in every figure. In the figures:

FIG. 1A is a diagram of a tanker truck with an overfill detection and control system;

FIG. 1B is a diagram of a tanker truck safety and identification system including a truck controller;

FIG. 2 is a schematic representation of a tanker truck connection socket;

FIG. 3 is a perspective view of one example of a portable truck tester in accord with aspects of the disclosed technology;

FIGS. 4A and 4B are bottom views of an example of the portable truck tester of FIG. 3 in accord with aspects of the disclosed technology;

FIG. 5 is a cross-sectional view of one example of a portable truck tester in accord with aspects of the disclosed technology;

FIG. 6 is a functional block diagram of electronic components of an example of the portable truck tester according to aspects of the disclosed technology;

FIG. 7 is an illustration of one example of a computing device hosting a tester application in accord with aspects of the disclosed technology;

FIGS. 8A-F are diagrams illustrating examples of a user interface of a tester application in accord with aspects of the disclosed technology;

FIG. 9 is a flow diagram of one example of a process of testing a tanker truck safety and identification system in accord with aspects of the disclosed technology; and

FIG. 10 is a flow diagram of one example of a process of using a portable truck tester and tester application in accord with aspects of the disclosed technology.

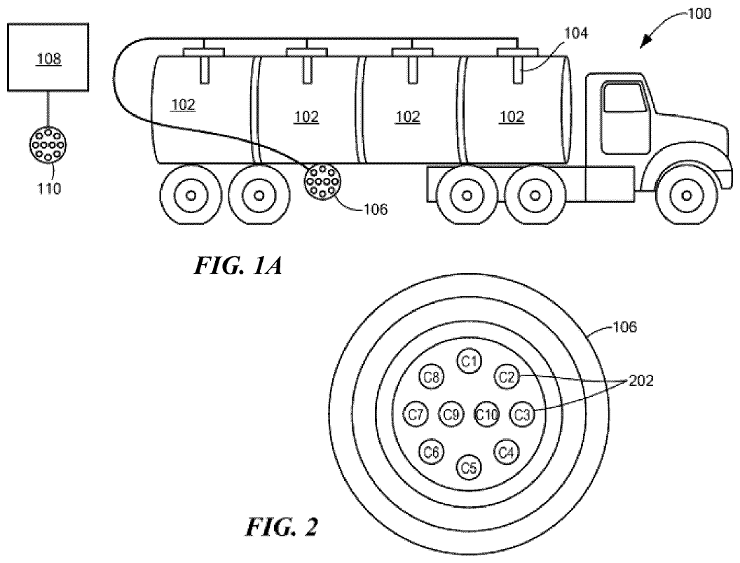

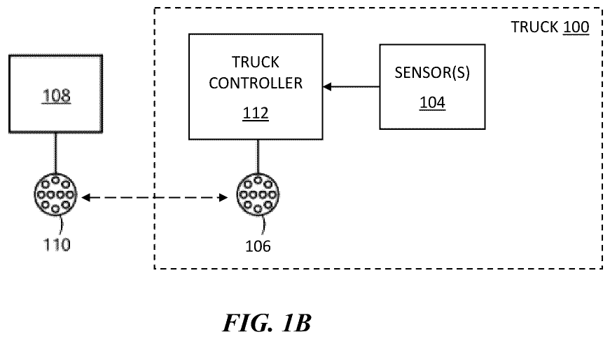

### DETAILED DESCRIPTION

Aspects and embodiments are directed to a multi-mode tanker truck tester system and methods associated therewith. As used herein, the term “tanker truck” is intended to refer to any truck, trailer, or truck and trailer combination, as well as any other type of tank vehicle or portable tank, including water-based transport vehicles (such as tanker ships or tanks transported on ships) and rail-based transport vehicles, as well as road-based transport vehicles, having one or more dedicated compartments for the transport of cargo fluids. As used herein, the term “cargo fluids” is intended to refer to fluids being transported from one location to another and not used by the truck, trailer, truck and trailer combination, or other vehicle for operation of the vehicle during the transport of the cargo fluids. Additionally, the term “cargo fluids” is intended to refer to any fluids, including hazardous or non-hazardous liquids (such as water, fuels, (e.g., petroleum, diesel, kerosene, jet fuel, etc.), acidic or alkaline solutions, chemicals, food products, or beverages, to name a few examples), viscous compounds (such as cement, syrups, etc.), flowable solids (such as sand, grains, seeds, etc.), and/or flowable slushes or mixtures.

In some embodiments, for example, a dual-mode portable device for determining a status of a tanker truck safety and identification system comprises a housing having a plurality of pins arranged therein, the pins being configured to couple with corresponding contact pads on the tanker truck safety and identification system. A memory and a display are also incorporated in and/or on the housing. In examples, the portable device further comprises a wireless communication interface configured to support communication of data via at least one network protocol, and a microprocessor coupled to the plurality of pins, to the memory, and to the wireless communication interface. The microprocessor can be configured to run a program to test various components and aspects of the tanker truck safety and identification system to determine the status of the system. In a first mode of operation of the dual-mode portable device, the microprocessor can be configured to cause information regarding the status of the tanker truck safety and identification system to be displayed on the display and, upon completion of the program, store the information regarding the status of the tanker truck safety and identification in the memory. In a second mode of operation of the dual-mode portable device, the microprocessor can be configured to establish a connection with a remote device via the wireless communication interface, receive, via the wireless communication interface, testing instructions from the remote device to control running of the program, and transmit the information regarding the status of the tanker truck safety and identification to the remote device via the wireless communication system. In some examples, in the second mode of operation, the microprocessor can be configured to begin running of the program and reporting of the information to the remote device autonomously without receiving the testing instructions. The information reported to the remote device may include test results from the current program run, or stored test results from one or more prior program runs. These and other examples are described further below.

### OVERVIEW

As discussed above, there is need for systems that allow for the testing of various safety and/or identification systems on tanker trucks to ensure the safe and reliable loading, transport, and delivery of cargo fluids.

Accordingly, aspects and embodiments provide a hand-held, portable truck tester that can be used to check and validate the operation of tank truck overfill prevention, grounding, and vehicle identification systems. In some examples, the truck tester is configured to check and validate vehicle safety and/or identification systems according to industry standard criteria, such as those used by conventional loading rack controllers, but is contained in a small, portable, battery-operated unit. For example, embodiments of the truck tester can be used to validate the status of 2-wire and/or 5-wire optic sensors as well as grounding devices, such as ground bolts and ground balls, on the vehicle. In other examples, the truck tester can be configured to test and validate other types of fluid detection sensors that may be part of a safety and/or identification system, possibly depending on the type of fluid being transported. The truck tester may also be used to read the truck ID and/or other data from an installed T.I.M. or other identification module on the vehicle. Furthermore, embodiments of the truck tester have the capability to wirelessly interface and communicate with one or more remote devices to provide remote diagnostics and review of test results accumulated over multiple testing sessions and multiple vehicles, as well as real-time remote monitoring and/or control of vehicle testing.

Embodiments described herein provide the ability to verify the performance of safety systems on tanker trucks during installation and repair, and to save time and reduce costs by providing a quick and easy approach for testing installed components. In addition, the truck tester can be used to ensure that tanker trucks are clear to load when arriving at a terminal, which may save time and cost while reducing the risk of a vehicle being turned away at the terminal by errors reported on the loading rack controller.

As described further below, according to certain embodiments, a truck tester is capable of operating in at least two different modes. In a first mode (also referred to herein as a basic mode), the truck tester is capable of operating as a stand-alone device that can perform tests and provide test result information, such as a pass/fail (also referred to as “go or no-go”) indicator, some sensor status information, and/or tanker truck grounding information, via an integrated display. The truck tester may further be capable of storing test result information for multiple test sessions, for example, up to ten or twenty test sessions, for access and review at later times. In addition, in the first mode of operation, the truck tester can be used for wet-testing of a vehicle, as described further below. In a second mode of operation (also referred to herein as an advanced mode), the truck tester is capable of operating as a wirelessly connected unit that can provide more detailed information regarding the configuration and status of a tanker truck at the time of testing. Operating the truck tester in the second mode of operation together with a wirelessly connected device, a user may be able to generate, save, and print testing reports, such as a safe loading pass, for example. To allow for advanced mode operation, examples of the truck tester may include a firmware image and wireless communication interface (e.g., including a WIFI and/or BLUETOOTH Low Energy (BLE) radio) that provides wireless communication capability, as well as additional reporting capability, as described further below. In some examples, a client application (“app”) installed on a remote computing device, such as a laptop, tablet, mobile phone, etc., communicates with the truck tester in the advanced mode to provide the various features and functionality described herein. Thus, in the second mode of operation, the truck tester may provide all functionality associated with the first mode of operation, as well as additional reporting and other capabilities as described further below.

By providing dual-mode operation capability, embodiments of the truck tester can offer both a simple, easy-to-use, testing tool as well as a powerful diagnostic and reporting system in a small, convenient package. Individual users can enable functionality as needed, and remote operators can view, save, and share a wide range of testing information through a user-friendly interface that can be accessed on a computing device of their choice.

### Example Device Configurations

As described above, a tanker truck may carry either a 2-wire or 5-wire configuration of sensors. According to certain examples, the truck tester can automatically determine which type of sensor is in use, as well as what grounding system is used, and then run one or more test programs to test the sensors and/or grounding system. In some implementations, the truck tester couples with the connection socket 106 on the tanker truck 100 (an example of which is shown in FIG. 2) that includes a plurality of contact pads 202. The contact pads 202 are arranged in a specific orientation such that a particular pad location corresponds to a particular function, for example, ground, a signal input, or a signal output. Accordingly, the contact pads 202 are numbered (C1-C10) and assigned specific signals that have become an industry standard. The signals assigned to the contact pads, depending on the configuration of the sensors, are presented in Table 1. In the 2-wire system, a “dummy” sensor is used to “fill in” for missing sensors on a truck. If, for example, there are less than eight tanks on a truck, a dummy sensor is used to mimic, or appear as, a dry sensor for each of the unused sensor locations on the connector. A single dummy sensor apparatus can mimic up to five sensors.

TABLE 1
Example Sensor Configurations

| Contact Pad Number | 2-Wire system | 5-Wire Optic System |
|---|---|---|
| C1 | Sensor 1 | Not used |
| C2 | Sensor 2 or Dummy | Not used |
| C3 | Sensor 3 or Dummy | Not used |
| C4 | Sensor 4 or Dummy | Pulse to Sensors |
| C5 | Sensor 5 or Dummy | Diagnostic Line |
| C6 | Sensor 6 or Dummy | Pulse from Sensors |
| C7 | Sensor 7 or Dummy | Not used |
| C8 | Sensor 8 or Dummy | Sensor Power |
| C9 | Ground/T.I.M. | Ground/T.I.M. |
| C10 | Ground | Ground |

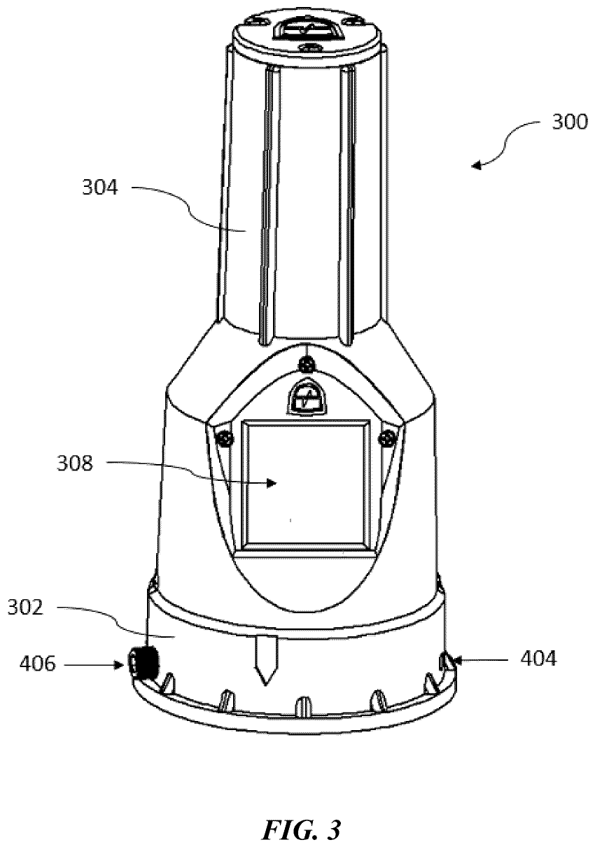

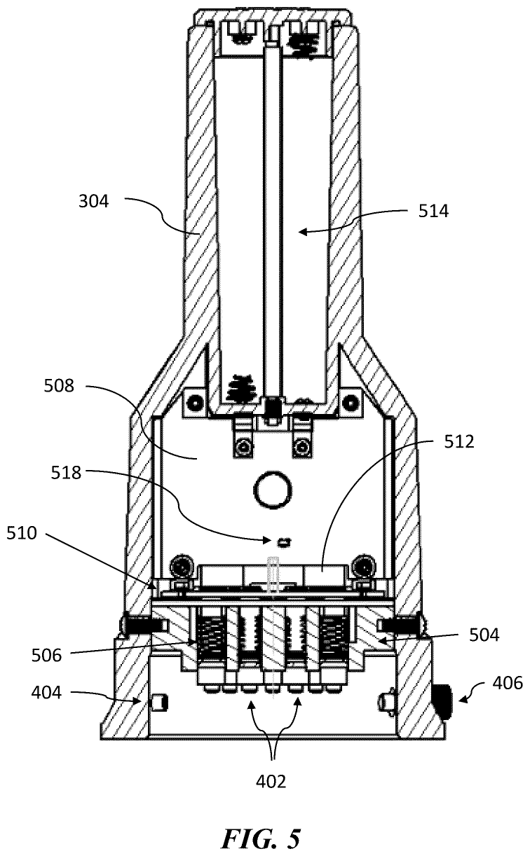

FIG. 3 is a perspective view of an example of a portable truck tester according to certain embodiments. The truck tester 300 includes a coupling portion 302 for connecting to the connection socket 106 on the tanker truck 100. The portable truck tester 300 also includes a handle portion 304 to facilitate connecting and disconnecting to the connection socket 106. In one embodiment of the portable truck tester 300, the handle portion 304 is generally cylindrical and is hollow to accommodate the internal components of the truck tester 300. In some examples, the handle portion 304 includes a battery compartment (FIG. 5) that can be used to accommodate one or more batteries to provide power for the tester 300, for example. A display panel 308 is incorporated into the handle portion 304 in order to display information (e.g., the status of the tanker truck 100 under test and/or some other test result information) to the user, as described further below. The display panel may be a high definition light emitting diode (LED) display or other type of display.

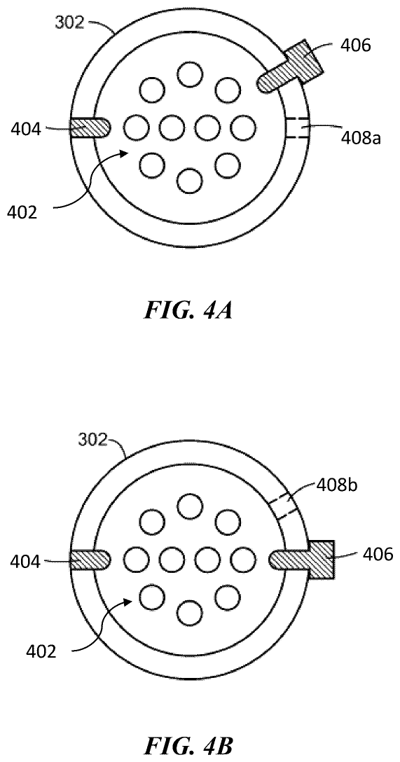

Referring to FIGS. 4A and 4B, the connection portion 302 of the truck tester 300 includes a plurality of contact pins 402 for connecting to the contact pads 202 on the connection socket 106. As described above, the truck tester 300 advantageously may be used to test either 2-wire or 5-wire truck sensor systems, which (as shown in Table 1 above) have different configurations of the contact pads 202. The different sensor systems may also have slightly different configurations of the connection socket 106. In particular, although not shown in FIG. 2, the perimeter of the connection socket 106 may have pin slots in differing positions to prevent a plug 110 meant for a 2-wire system from being plugged into a connection socket 106 for a 5-wire sensor system or vice versa. These pin slots of located in certain industry standard positions. Accordingly, as shown in FIGS. 4A and 4B, in examples, the truck tester 300 includes a fixed pin 404 and a movable pin 406 that can be moved between a first slot 408a in one location on the perimeter of the connection portion 302 and a second slot 408b in another location on the perimeter of the connection portion 302. By moving the movable pin 406 between the two different positions, the different configurations of the connection socket 106 can be accommodated, thus allowing the truck tester to be used with either sensor system.

FIG. 5 illustrates a cross-sectional view of an example of the truck tester 300. As shown, the plurality of contact pins 402 are accommodated within a mating block 504, each contact pin 402 being disposed within a corresponding tube or channel within the mating block 504. In some examples, the contact pins 402 are spring-loaded pins such that the truck tester can accommodate connection sockets 106 that may have contact pads 202 that vary in height or are a variable distance from the originally set up connector. Accordingly, in such examples, each pin 402 has a corresponding spring 506 that is configured to urge the contact pin 402 towards any corresponding contact pad 202.

The truck tester 300 includes electronics 508 that may include various circuitry and components, including at least one microprocessor and a wireless communication interface, as described further below, that are mounted on one or more printed circuit boards (PCBs) or other electronics substrates. In some examples, the springs 506 are electrically conductive and electrical signals from the contact pins 402 are transferred to the electronics 508 via the springs 506, a contact PCB 510, and contact PCB connector 512. In some examples, the contact PCB 510 is mechanically coupled to the mating block 504 and electrically coupled to the respective springs 506. The electronics 508 can be coupled to signal traces on the contact PCB 510 (that are electrically connected to the contact pins 402 via the springs 506) via the contact PCB connector 510. This arrangement can provide for a robust, reliable electrical connection between the contact pins 402 and the electronics 508. However, in other examples, any of various other arrangements and circuitry can be used to form electrical connections to convey electrical signals from the contact pins 402 to the electronics 508. Through these electrical connections, when the truck tester 300 is coupled to a tanker truck via the connection socket 106, various components of the electronics 508 can be in electrical and functional contact with devices (e.g., sensors, T.I.M. module, etc.) on the tanker truck under test.

In some embodiments, the truck tester 300 is normally powered off and does not turn itself on until it detects that it has been plugged into a truck's connection socket 106. Accordingly, in some examples, the truck tester 300 includes a magnetic proximity switch 518 that can be used to determine when the truck tester 300 has been connected to a tanker truck 100 for testing. For example, a magnet (not shown) can be positioned on one of the contact pins 402 and the magnetic proximity switch 518 positioned relative to that contact pin 402 such that, when the contact pin 402 makes contact with a contact pad 202, it is urged towards the magnetic proximity switch 518. Thus, the proximity of the magnet to the magnetic proximity switch 518 can cause the magnetic proximity switch 518 to trigger the electronics 508 (or one or more components thereof) to power up and commence testing the equipment on the tanker truck. In other examples, a mechanism other than the magnetic proximity switch 518 can be used to detect compression of one or more of the contact pins 402 when the truck tester is connected to the connection socket 106. Once removed from the connection socket 106, the truck tester 300 may shut down after a programmable delay time. Thus, the truck tester 300 can be automatically powered on and off, with no need for a manual user-actuated on/off switch or power button. In some examples, however, the truck tester 300 can be provided with a mechanism for manually turning the device on without connecting it to a connection socket 106. For example, one of the contact pins 402 may be made slightly longer than the others, and the truck tester 300 may be powered on by pressing the longer contact pin. In such instances, the truck tester 300 may still automatically shut down after the programmable delay time.

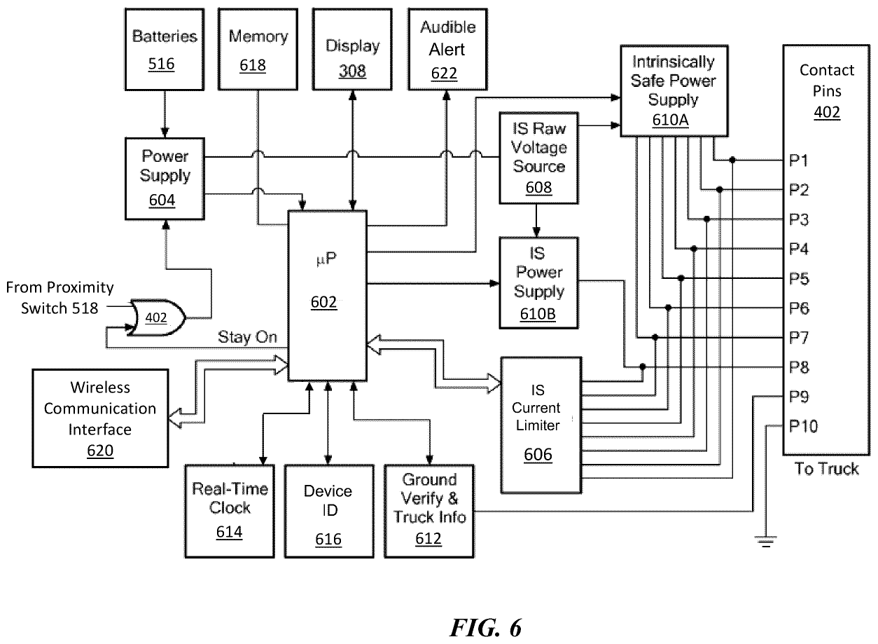

The electronics 508 can be configured to provide a comprehensive test of one or more components of the safety and identification system on a tanker truck 100. FIG. 6 is a functional block diagram of one example of components of the electronics 508 according to certain embodiments. As shown, the electronics 508 includes a microprocessor 602 that can be configured to run various tests and processes, via firmware and/or software, as described in more detail below. As described above, embodiments of the truck tester 300 are capable of operating as a stand-alone unit in the first (basic) mode and as part of an integrated system in the second (advanced) mode. When operating in the first (basic) mode, embodiments of the truck tester 300 can independently perform various tests of a tanker truck safety and identification system. When operating in the second (advanced) mode, embodiments of the truck tester 300 can be paired with a remote computing device that is running a tester application to access additional functionality. The remote device can be any type of computing device (e.g., a laptop, tablet, mobile phone, desktop computer, etc.) that executes an operating system (e.g., ANDROID, IOS, etc.) capable of supporting the tester application. In examples, an integrated system operating with the truck tester 300 in the advanced mode may be capable of providing all the testing functions that can be performed with truck tester 300 in the basic mode, as well as additional functionality. For example, the system may have the added ability to perform on-truck testing/debug of individual sensors (e.g., “in the field testing”), diagnostic testing of sensors, harnesses, and/or connectors (which may be performed in a laboratory or mechanic shop, for example), archival of historical test results from previous test sessions on one or more tanker trucks, and generation of reports and/or other safety compliance documents, as described below. In some examples, advanced mode firmware enables interoperation between the truck tester 300 and the tester application running on a remote device to enable control and data exchange during operation of the truck tester 300. In the advanced mode, the truck tester 300 may provide data, as requested by the remote device, and react appropriately to remote commands while simultaneously performing various testing functions under control of the microprocessor 602, as described further below. In addition, the microprocessor 602 may be capable of configuring the truck tester 300 between the first (basic) and second (advanced) modes of operation in response to input received from a user or via a remote device.

An internal power supply 604 provides power to the microprocessor 602 various other components of the electronics 508. In some examples, the power supply 604 generates its output voltage from the batteries 516. In some examples, the magnetic proximity switch 518 is used to turn on the power supply 604 and, therefore, when the truck tester 300 is not connected to a truck under test, power is generally being conserved. Once the magnetic proximity switch 518 detects that the truck tester 300 is coupled to a truck under test, the power supply 604 turns on and the microprocessor 602 initiates its startup program and then also, from that point forward, may control the operation of the electronics 508 and, at the completion of testing, may shut itself down.

As described above, in some instances the tanker truck 100 may be transporting hazardous fluids, such as flammable fluids, for example. Accordingly, as the truck tester 300 therefore may be used in an environment in which extraneous sparks or voltage or current signals must be carefully controlled in order to prevent catastrophic consequences, an intrinsically safe (IS) interface is provided at the contact pins 402. The intrinsically safe interface limits maximum power to 1.3 watts, in some examples. The intrinsically safe interface may include an intrinsically safe current limiter 606, an intrinsically safe (IS) raw voltage supply 608, and intrinsically safe power supplies 610A and 610B.

In some examples, the intrinsically safe raw voltage supply 608 receives power from the internal power supply 604 and generates two separate intrinsically safe voltage outputs or “power rails.” These two voltage outputs can be used to separately power different groups of pins by, respectively, two separate intrinsically safe power supplies 608A and 608B that are used to provide intrinsically safe power to the contact pins 402 in order to provide power and/or signals to the tanker truck under test. Each of the intrinsically safe power supplies 610A, 610B is controlled by the microprocessor 602 to provide power to the contact pins 402 separately or in any combination. The microprocessor 602 also detects signals from the contact pins 402 through the intrinsically safe current limiter 606 provided inline between the microprocessor 602 and the contact pins 402.

As described above, in some examples, the truck tester 300 is configured to test 2-wire or 5-wire tanker truck sensor systems. As also noted above, in 2-wire systems, dummy sensors are provided on tanker trucks to account for unused or not-present compartments. The dummy sensors take power from pin 8. Each dummy sensor can simulate up to five sensors. The 5-wire sensors use five wires simultaneously and use power on pin 8, which does not interfere with the sensor being tested. To accommodate both scenarios, the electronics 508 includes the two separate intrinsically safe power supplies 608A and 608B. The first intrinsically safe power supply 610A provides power to pins P1-P7. The second intrinsically safe power supply 610B provides power to just pin P8. Thus, the “power rail” applied to pins P1-P7 is different from that applied to pin P8. This separation provides an advantage in that voltage measurements made on the pins P1-P7 are separated from those on the pin P8. Accordingly, the second intrinsically safe power supply 610B can be used to power either a dummy in 2-wire mode or provide power in 5-wire mode. Further, more accurate sensor testing can be achieved due to minimized interference or cross-over on the voltage supply lines.

Still referring to FIG. 6, in some examples, the electronics 508 further includes a ground verify or detection and truck information module (T.I.M.) tester 612 that is in communication with one of the contact pins 402 and with the microprocessor 602. A ground detection circuit in the module 612 can include the capability to detect either a resistive mode or a ground bolt mode of the tanker truck grounding equipment, and to verify operation.

As discussed above, in certain instances, a tanker truck 100 under test includes an onboard truck controller 112. Accordingly, in certain examples, the truck tester 300, via the electronics 508 and software executed by the microprocessor 602, is further configured to detect whether or not the tanker truck 100 under test has a tanker controller 112 connected to the connection socket 106. In such instances, the truck tester 300 can be connected to the truck controller 112 via the connection socket 106 and the contact pins 406. The truck tester 300 may determine when it is communication with a truck controller 112 rather than the individual sensors 104, and may indicate the detected presence of the truck controller 112 on the display panel 308. The microprocessor 602 can be further configured to run tests to detect an open, short, permit or non-permit condition on the connection to the truck controller 112.

A real time clock 614 provides the microprocessor 602 with real time date and time information. With the onboard real time clock 614, a license expiration date and custom configuration can be stored. For example, a device ID module 616 can be used to hold a serial number value that can be accessed by the microprocessor 602. Such a serial number may be used, in conjunction with the real time clock module 614, to confirm that a valid license is in place in order to operate the truck tester 300. When the current date reaches the expiration date, for example, a message may be reported and the truck tester 300 will no longer perform any truck testing. In some examples, the device ID module 616 stores a unique ID for identifying the particular truck tester 300 device. This ID may be derived from the serial number value and may include a user-defined text field to allow users to name each particular truck tester 300 for ease of identification and selection through the tester application, as described further below. In some examples, the truck tester firmware supports the necessary functions to maintain and update the real time clock 614. When the truck tester 300 is operating in the advanced mode, correct synchronization of the real time clock 614 may be important for the integrity of generated test session data sets and reporting functions provided by the tester application described further below. In some examples, the firmware includes a time zone field to indicate which time zone is being used when the real time clock 614 is being read or updated.

A memory component 618 is provided to store the program(s) run by the microprocessor 602. This memory component 618 may include any computer-readable or machine-readable storage medium, including non-volatile and/or volatile RAM. The memory component 618 may further store test results from one or more test sessions, and other information, as described further below. In some examples, the memory component 618 may include a hard-drive, such as a solid state hard drive, or other storage device(s) for storing additional data. In some examples, the device ID module 616 is part of the memory component 618, or the device ID module 616 and the memory component 618 may share one or more common storage media. In some examples, when the truck tester 300 is activated and the microprocessor 602 runs one or more programs as part of a testing session, a record of the test results can be saved in a data set, along with a time stamp from the real time clock 614, in the memory component 618. In some examples, the memory component 618 can be configured with sufficient capacity to store at least 5, 10, or some other selected number of data sets, before an oldest data set is deleted to free up space to save a new data set.

As described above, the truck tester 300 includes a wireless communication interface 620 configured to support wireless communication of data via at least one network protocol to one or more remote devices. In some examples, the wireless communication interface 620 includes a WIFI and/or BLUETOOTH (e.g., BLE) radio, along with any supporting circuitry and antenna(s). In certain examples, the wireless communication interface 620 is capable of supporting BLE version 4.2 or later. In some examples, the truck tester 300 can receive programming information, such as firmware updates, for example, from the tester application (executing on a remote device) via the wireless communication interface 620.

In some examples, the wireless connection established by the wireless communication interface 620 is configured to be active and available when the truck tester 300 is powered on and its advanced mode of operation is enabled. If the truck tester 300 is powered on, but the advanced mode of operation is not enabled, the wireless connection may not be active or powered. In some examples, for enhanced security, the wireless communication interface 620, optionally under control of the microprocessor 602, can be configured to establish the wireless connection only in response to connection requests from a remote device that originate via the tester application running on the remote device and include suitable device-specific credentials. For example, upon power-up and enabling of the advanced mode of operation, the truck tester 300 may be available to receive, via the wireless communication interface 620, pairing requests sent via the tester application from remote devices. Each pairing request may include credentials, such as an access code or other security and/or identification information, which may also be stored in the device ID module 616 and/or memory component 618, such that the microprocessor 602 can verify the credentials. In some examples, the truck tester 300 can be configured to pair with a single instance of the tester application at a time. Thus, once credentials have been validated and a pairing request is accepted, the truck tester 300 can be configured to reject additional incoming pairing requests until the existing connection is terminated. The truck tester 300 can be further configured to reject incoming messages or connection requests that do not originate from a recognized tester application executing on a remote device.

Although not shown in FIG. 6, the electronics 508 may further include any I/O devices necessary to communicate via the wireless communication interface 620, if not otherwise provided for within the microprocessor 602 or other circuitry.

As the environment in which the truck tester 300 may be used is often not amenable to allowing for easy viewing of the display 308, some embodiments provide an audible alert 622 that is asserted in various scenarios. For example, the audible alert 622 can be activated when the truck tester 300 has completed a test, or if a sensor or other piece of equipment fails a test. In this way, a user may be notified to view the display 308. In some examples, when testing is complete, the results may be observed for a predetermined amount of time afterwards by disconnecting the truck tester 300 from the connection socket 106 and viewing the information on the display 308.

As described above, the display 308 may be an LED display, LCD, or other type of display that can present various information to a user, including some test results and the status of the tanker truck 100 under test. In the basic mode of operation, upon completion of a test, the display 308 displays the status of the tanker truck under test (e.g., pass/fail) and, in some examples, the status of individual sensors. For example, the display 308 may display a green symbol for each sensor that passed the test and a red symbol for each sensor that did not pass the test. In some examples, the display 308 displays a symbol for each sensor having a fault condition, indicating whether the sensor is “wet,” “shorted,” or “open.” Various other display options that can convey the sensor status to the user may be implemented. The display 308 may also display various other information, such as status information relating to the truck tester itself. For example, upon power-on, the display 308 may display a current version number of the installed firmware and a battery power level. In the advanced mode of operation, the display 308 may also display the status of the wireless connection (e.g., connected, searching, etc.) and a wireless signal strength, for example. Display of various other information may also be implemented.

As discussed above, in the advanced mode of operation, the truck tester 300 pairs with a remote computing device running the tester application software. The tester application can be installed on any ANDROID, IOS, or other computing device. When properly configured, the tester application can be used to connect to one truck tester 300 at a time. The tester application may present a user-friendly graphical user interface that allows users to access information and functionality through various menus, buttons, links, pop-up windows, or other navigation features. In some examples, the graphical user interface is automatically scalable to support different screen sizes associated with different computing devices.

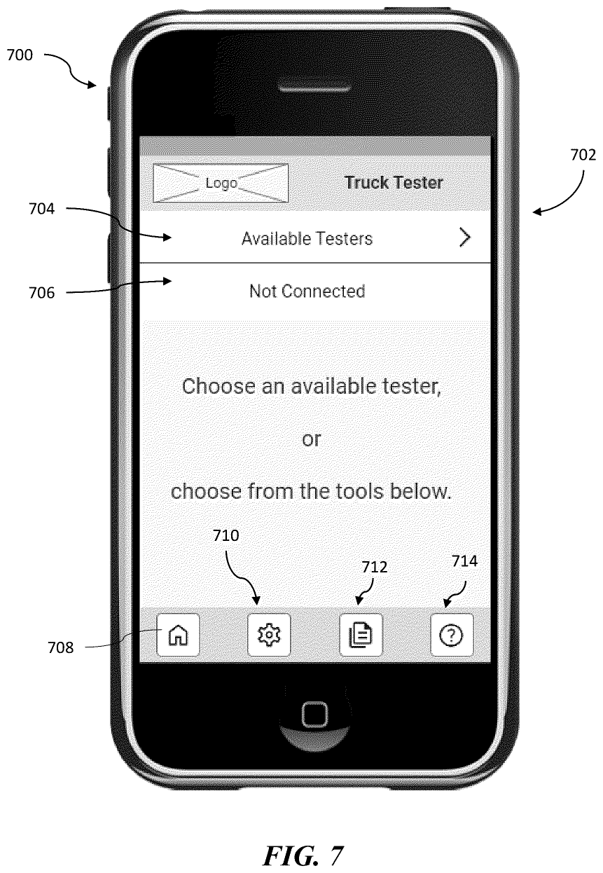

According to certain examples, once initialized, the tester application may automatically detect all available truck testers 300 within range of the wireless connection and provide the user with a list of available truck testers to connect. For example, referring to FIG. 7, there is illustrated an example of a computing device 700 (e.g., a mobile phone) displaying a home screen 702 of an example of the tester application, as may be viewed after the tester application is selected by a user. As shown, the tester application may display a selectable menu 704 of available truck testers. If the user selects the menu 704 (e.g., by clicking or otherwise engaging with the > symbol), a list of available truck testers may be displayed. In some examples, each available truck tester 300 may be listed by its user-defined name (as described above with reference to the device ID module 616). In the event of more than one truck tester 300 with the same given name, or if the name field is undefined, then the truck tester serial number may be displayed. Optionally a pop-up window may be used to display the available truck tester serial number(s). When a target truck tester 300 is selected, the tester application may initiate a pairing with it, as described above. Once paired with a particular truck tester 300, the tester application may provide a user with a wide range of functions and information relating to the paired truck tester 300.

In some examples, the home screen 702 may further display a status bar 706 (or other icon) indicating whether or not the tester application is paired with a truck tester 300. The home screen 702 may further include various navigation icons, including a home icon 708, a settings icon 710, a data icon 712, and a help icon 714. In some examples, the navigation icons may be presented in all, or almost all, screens of the tester application, not only the home screen 702. The home icon may allow a user a quick option for returning to the home screen 702 from any other screen in the tester application. The settings icon 710 may provide a shortcut for a user to access a settings menu, as described further below. The data icon 712 may allow the user to access various reports and other information relating to ongoing or past testing sessions of one or more truck testers 300. The help icon 714 may allow the user to access information to assist the user in navigating and using the tester application. In some instances, the information and/or functionality available through the tester application may vary depending on whether or not the tester application is currently paired with a truck tester 300. For example, stored historical test data and reports may be accessible even if the tester application is not currently paired with a truck tester 300. However, settings and current testing information may only be available when the tester application is paired with a truck tester 300.

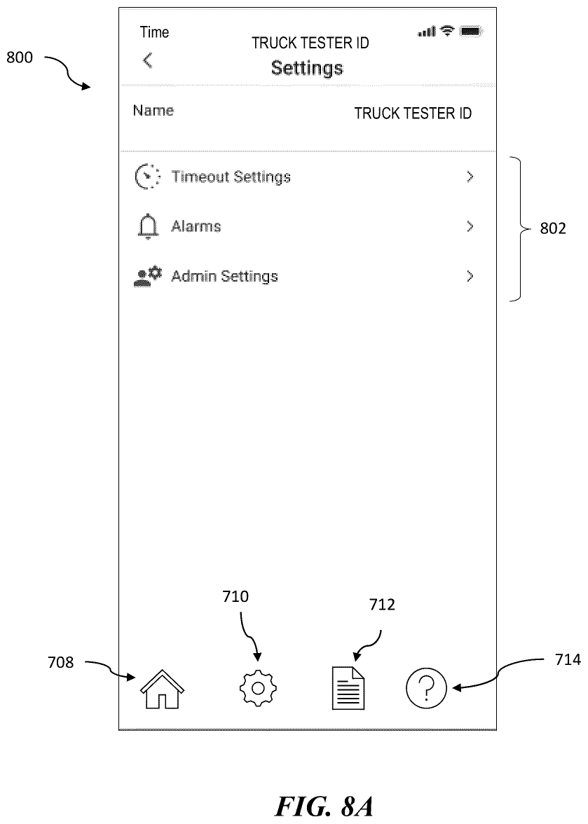

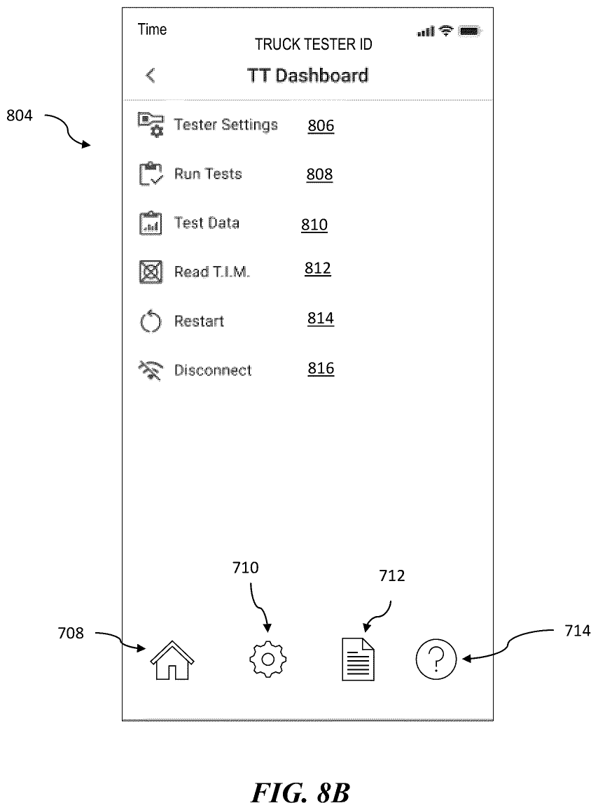

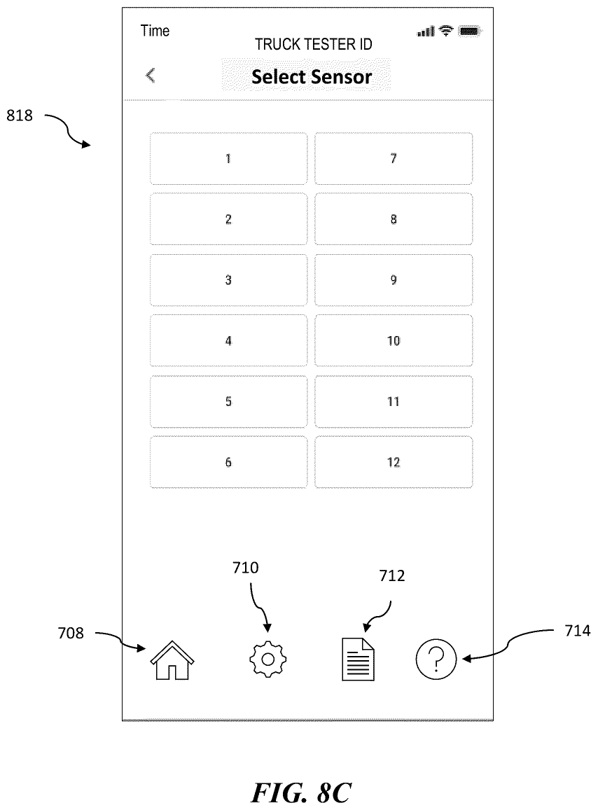

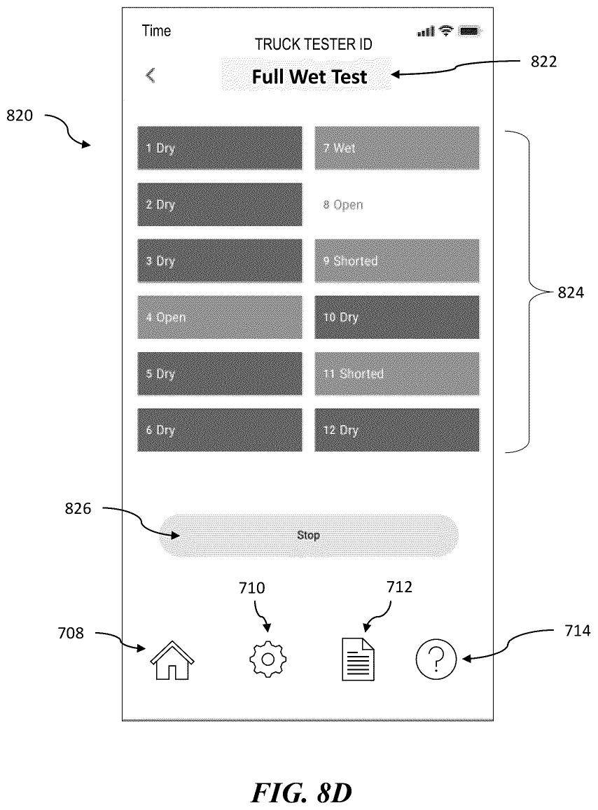

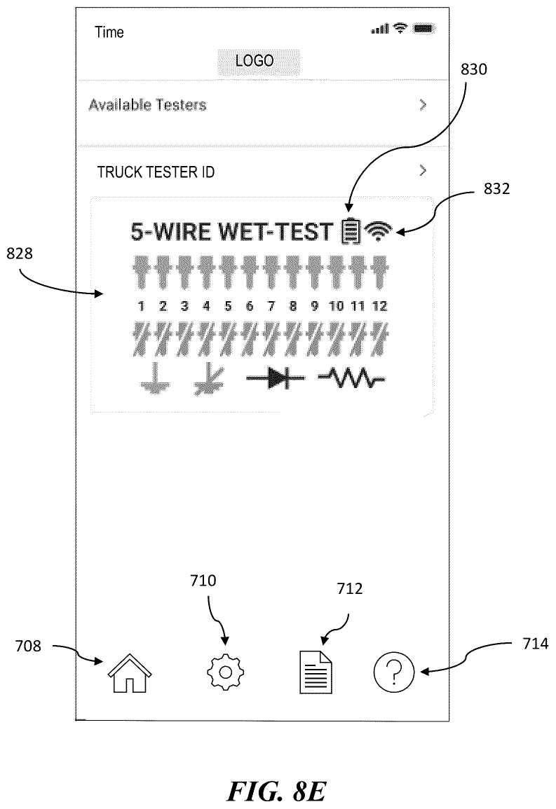

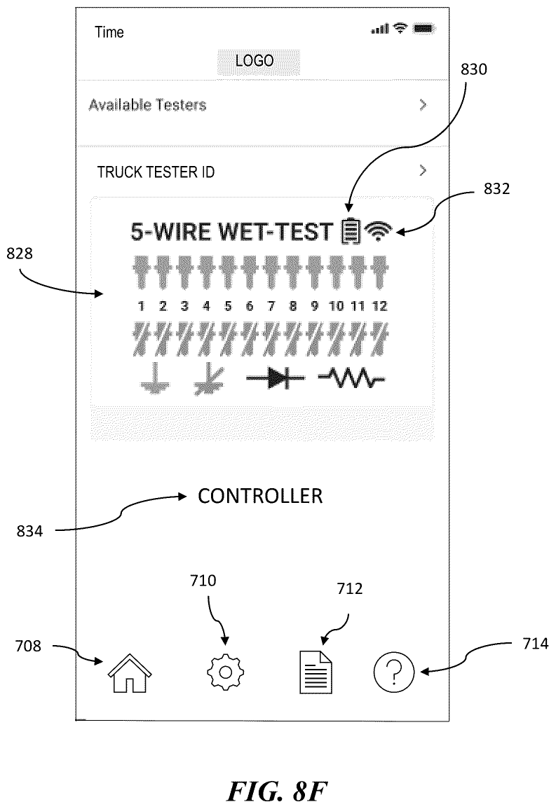

FIG. 8A illustrates an example of a settings screen 800 (e.g., accessed via the settings icon 710 or by navigating through other menus and/or buttons) that may be presented to a user of the tester application once the tester application has paired with a truck tester 300. The settings screen 800 may display the paired truck tester ID and offer various menus 802 through which the user can view and/or alter settings of the truck tester 300. For example, if the user has suitable supervisor credentials, the user may be able to access administrator (“admin”) settings to update configuration settings or operating parameters of the truck tester 300 and/or download new software or firmware to the truck tester 300. The settings screen 800 may also provide menus and options for configuring various alarms of the tester application (e.g., the tester application can be configured to provide audible alerts similar to the truck tester 300 itself) and/or the truck tester (e.g., the sound, duration, volume, and/or triggers for the audible alert 622) and/or timeout settings (e.g., the duration of the programmable delay between disconnecting the truck tester 300 and the power-down sequence discussed above). In some examples, through the settings, the tester application may provide the ability for users to reset or update the internal real time clock 614 on the truck tester 300.

According to certain examples, once paired with a truck tester 300, the tester application may provide a “dashboard” screen to allow the user to access various functionality associated with the truck tester 300. FIG. 8B illustrates an example of such a dashboard screen 804. For example, the dashboard screen 804 may provide a path, indicated at 806, (in addition to the settings icon 710) to allow the user to access the settings screen 800 discussed above. Through the dashboard screen 804, the tester application may allow a user to command the truck tester 300 to run one or more testing activities (under control of the microprocessor 602), including 2-wire or 5-wire sensor testing, ground testing, identification verification, etc., as indicated at 808. In some examples, the tester application may allow a user to command individual sensor channel tests or continuous sweep testing of connected sensors, or other test sequences. For example, FIG. 8C illustrates an example of a tester application screen 818 that allows the user to select individual sensors for testing. In some examples, a user may navigate from the “run tests” option at 808 through one or more menus that offer tests that can run, similar to the settings menus offered via the settings screen 804 shown in FIG. 8A. Various navigation options will be apparent given the benefit of this disclosure.

During and/or after a test session, the tester application may display the test results to the user. For example, FIG. 8D illustrates an example of a display screen 820 displaying results of a sensor test according to some embodiments. The display screen 820 may include an identification of the type of test being run (indicated at 822) and the results of the test for individual sensors, as shown at 824. As discussed above, in some examples, sensors that “pass” the test (e.g., are dry) may be indicated in green, whereas sensors that “fail” the test (e.g., wet, shorted, open, etc.) may be indicated in red. In other examples, a different color scheme may be used. In some examples, if the test results are being displayed in real-time while the test is being run, the display screen 820 may include an option for the user to stop the test, as indicated at 826. Referring to FIG. 8E, in some examples, the tester application is configured to display a virtual real-time image of the truck tester display 308, as indicated at 828. As described above, the truck tester display 308 may display information regarding the test being run (5-wire wet test in the example of FIG. 8E), the status of each of the sensors being tested (as shown at 828), and diagnostic information relating to the truck tester 300 itself, such as the battery level (indicated at 830) and/or wireless connection (indicated at 832).

As discussed above, in some examples, a tanker truck 100 includes an on-board tanker controller 112 that can interface between the sensors 104 and the connection socket 106, and truck tester 300 can be configured to detect the presence of such a truck controller. As discussed above, when the presence of a truck controller 112 is detected, the truck tester may display an indication of the presence of the truck controller on its display panel 308. Accordingly, in such examples, the tester application may similarly display the indicator 834 of the presence of the truck controller 112, as shown in FIG. 8F, for example.

It will be appreciated that FIGS. 7 and 8A-8F illustrate examples of an arrangement of screens that can be displayed by the tester application to convey information to users and allow users to access functionality associated with the truck tester 300 and the tester application. However, numerous other screens, menus, layouts, configurations, appearances, etc. may be implemented to convey this (and other) information and provide access to the functionality described herein, as will be apparent given the benefit of this disclosure. Accordingly, FIGS. 7 and 8A-E are illustrative only, and not intended to be limiting.

Returning to FIG. 8B, the tester application may further provide users with the ability to access test data from current and past testing sessions, as indicated at 810 and icon 712. For example, users may be able to download (from a connected truck tester 300) and save test results from current and previous test sessions (optionally up to a programmed limited number of test sessions (e.g., 5, 10, 20, etc.) or past time frame, e.g., test sessions from the prior week or month). In addition, the tester application (through the test data navigation options 810 or 712) may provide the user with the ability to generate test report files (e.g., spreadsheet format, text format, PDF format, etc.) from downloaded test data. These test report files can be saved on the computing device 700 or in network-connected external storage (e.g., cloud storage or another computing device), printed, and/or shared with other users and/or devices. In addition, in some examples, a “safe loading pass” can be created for a tanker truck based on test data indicating that the tanker truck safety and identification system has passed all tests and is in good working order. A safe loading pass may correspond to a particular industry-recognized test report format that includes specified test result data and tanker truck identification information.

In some examples, the tester application may further provide the ability for users to read T.I.M. information from a connected tanker truck, as indicated at 812. This information may include information such as identification information for the tanker truck, the number of compartments on the tanker truck, the types of fluids the tanker truck is authorized to transport, and/or various other information as known in the industry. This information can be included in the test results data downloaded from the truck tester 300 and in test reports generated from the test results data. In some examples, T.I.M. data can be displayed on one or more screens of the tester application as well as downloaded and saved.

In some examples, the tester application may further provide the ability for users to reset or restart a connected truck tester 300, as indicated at 814, and to disconnect from a connected truck tester 300 (e.g., by disabling the wireless connection to the truck tester 300), as indicated at 816, to allow the tester application to be paired with another truck tester 300.

Thus, by pairing the truck tester 300 with the tester application, a wide range of highly configurable functionality may be provided. The advanced mode of operation allows users to view, control, and adjust testing sessions and truck tester configuration from a remote location, and provides access to historical test data and a suite of reporting capabilities that can be used even when not connected to a particular truck tester. However, by also providing operation in the basic mode, the truck tester 300 may offer a quick, easy solution for testing a tanker truck safety and identification system that does not require any external connectivity. Thus, in some examples, one user may perform tanker truck testing using the truck tester in the first mode and store test results from one or more testing sessions in the memory component 618, as described above. At a later time, the first user may provide the truck tester 300 to another user, for example, who may have the tester application installed on their computing device (or who can download and install the tester application) and can pair with the truck tester 300 and download and save some or all of the stored test result data to access the reporting functionalities offline.

### Example Methodology

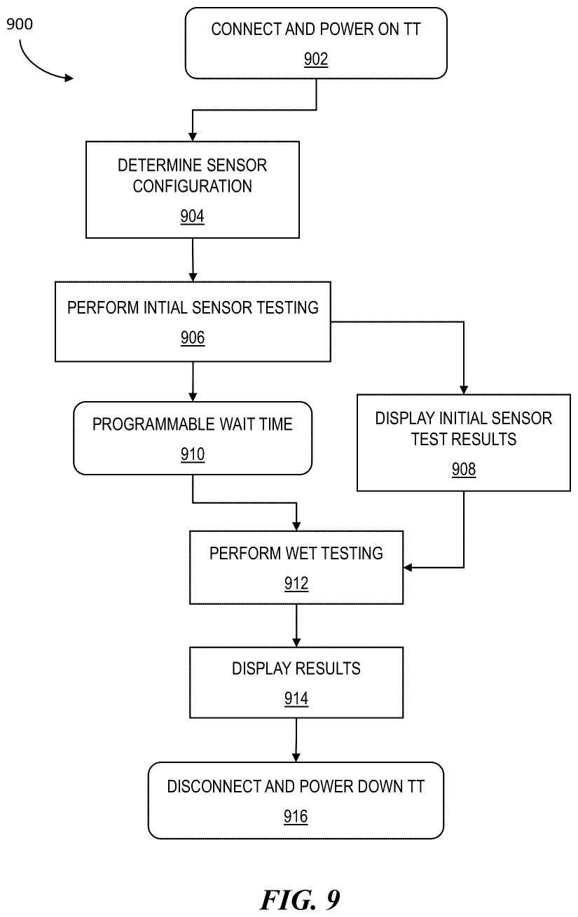

FIG. 9 is a flow diagram illustrating an example of a tanker truck testing process 900 that can be implemented using the truck tester 300 in either the basic or advanced modes of operation.

At operation 902, the truck tester 300 is connected to a connection socket and the microprocessor 602 and other electronics are powered on, as described above. Upon connection to a connection socket 106, the truck tester 300 may automatically begin a testing routine. In some examples, the truck tester 300 displays, on the display 308, start-up information, such as the firmware version, battery level, truck tester ID, and/or other information.

At operation 904, the truck tester 300 may determine the sensor configuration of the tanker truck 100 to which it has been connected. For example, the truck tester 300 may search for connected sensors and safety devices, including the T.I.M., the grounding connection, and the types and number of compartment sensors. As described above, embodiments of the truck tester 300 can automatically identify and test 2-wire or 5-wire optic (e.g., LED-based) compartment sensors. In one example, the truck tester determines whether the tanker truck 100 has a 5-wire sensor configuration by checking for open voltages on particular contact pins 402. If it is determined that the sensor system is not a 5-wire system, the truck tester may implement 2-wire sensor testing.

At operation 906, after identifying the sensor configuration at operation 904, the truck tester 300 performs an initial test of all installed sensors according to the identified configuration to check for any immediate faults or lack of connection of any of the sensors. In certain examples, initial testing at operation 906 may also include checking license information, as described above, to confirm that the truck tester 300 can be used to test the tanker truck 100. In other examples, this check may be performed as part of operation 904 or operation 912 discussed below.

The results of the initial sensor tests are displayed on the display 308 at operation 908. In some examples, the display 308 shows a green or red symbol for each sensor. A sensor that is wet or not operating properly may be designated with a red symbol. For 2-wire sensor configurations, the truck tester detects and displays dummy sensors as well as real sensors.

After the initial sensor test at operation 906 and a programmable waiting period, indicated at 910 (and during which time the initial test results are displayed on the display 308), the truck tester 300 enters a wet-test diagnostic mode at operation 912. During operation 912, the truck tester 300 may perform any diagnostic testing on the sensors or their wiring, including wet testing. Operation 912 may include a variety of different tests and/or sub-tests. These tests and/or sub-tests may be run according to one or more testing programs executed by the microprocessor 602. For example, for 2-wire configurations, the truck tester 300 may test each sensor, one at a time, rotating continuously from the first sensor (e.g., sensor 1) through the last sensor (e.g., sensor 12 or some other specified last sensor number). In some examples, performing 2-wire testing includes performing a short test on all sensors. The short test includes turning off all of the sensors and measuring the voltages to determine that each is below a predetermined threshold. If the voltages are below the threshold, then the voltages on two different subsets of pins are measured to assure that one set is above a first threshold and the other set is below a second threshold. If all of the sensors pass the short test, then each sensor may be turned on individually to detect any failed sensors. In this test, a plurality of pulses may be sent to each sensor in order to see if the sensor is operating correctly. In the 5-wire mode, the truck tester 300 may repeatedly send out pulses to the chain of sensors, as described above, to determine if each sensor is operating correctly.

Overfill sensors indicate that a corresponding tank chamber is at capacity by providing an indication when the sensor is “wet.” Thus, a full tank has a “wet” sensor and a tank that can accommodate more fuel has a “dry” sensor. In addition, these sensors “fail-safe” in that a defective sensor presents as being wet but a sensor that presents as being dry is working properly and not wet, i.e., the corresponding tank is not full. As a result, a sensor that returns a “wet” status is either defective or is working properly but in a full tank. The fail-safe mode prevents a fuel spill from occurring as the filling system will not put fuel in a tank indicating that it is full (a wet sensor), and it is better to assume a tank is full until there is confirmation otherwise. As noted above, a sensor is described as either “passing” or “failing.” In some tests, a sensor may be identified as failing if, for example, the truck tester 300 is unable to receive a signal where one is expected or receives a signal that is out of an expected range or set of parameters. In some instances, a sensor may be “wet” if its corresponding tank chamber is full. When tested, however, a sensor that reports as being wet is not necessarily in a failed condition, that is, it might not be defective, as it may be the case that the particular chamber is, indeed, full and this condition may or may not be known to the tanker truck driver or operator of the truck tester 300. Thus, where appropriate, it will be understood that an indication of a “failed” sensor is only used as an indication of the state of the sensor. In other words, the testing of sensors as used herein is meant to be an ascertaining of the status of the sensor, for example, dry, wet or not responding within acceptable parameters. The user may need to interpret the results provided by the truck tester 300 to determine the actual conditions present at the tanker truck 100.

Operation 912 may further comprise performing a ground test. There are at least two ways to implement ground on a tanker truck to prevent sparks during filling: diode or resistive grounding. Accordingly, in some examples, the truck tester 300 includes two test circuits and a determination of the type of grounding is made by the microprocessor 602 based on testing with the two test circuits. In some examples, performing a ground test involves charging a capacitor and then connecting it to the pin that would be connected to a grounding circuit on the tanker truck. The time it takes to discharge to below a threshold level is measured and if this time is below a predetermined time, then it is tested as a resistor ground, otherwise, tested as a diode ground. If it fails, the ground test is identified as having failed.

Operation 912 may further comprise performing an identification test, for example, a T.I.M. test. In one example, a T.I.M. test includes performing an attempt to successfully communicate with a T.I.M. on the tanker truck. For example, a reset command or serial number request may be sent from the microprocessor 602 to the truck T.I.M., and it is determined if a valid response is received. If the attempt is not successful, then the microprocessor may determine that either there is a bad T.I.M. or no T.I.M. is present on the tanker truck. Alternately, if the attempt to communicate is successful then the test identifies that the T.I.M. has passed.

At operation 914, the results of the test performed during operation 912 are displayed on the display 308. Operation 914 may be performed concurrently with operation 912, with the test results being updated as each test is performed.

Once the testing session is complete, the truck tester 300 can be disconnected from the connection socket 106, and automatically begin its power-down sequence, as indicated at 916 and as described above.

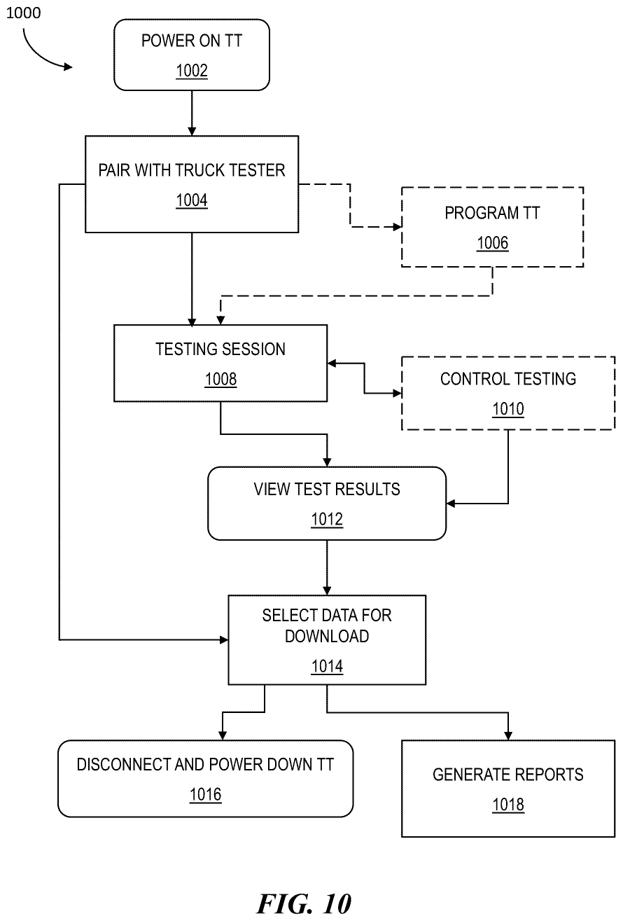

FIG. 10 is a flow diagram illustrating an example of a process 1000 of operating a truck tester 300 in the advanced mode and/or accessing certain advanced mode functionality.

At operation 1002, the truck tester 300 is powered on, either manually (as described above) or by connecting it to a connection socket 106 of a tanker truck 100 to be tested. In some examples, operation 1002 corresponds to operation 902 described above.

At operation 1004, the tester application is accessed and may be paired with the truck tester 300 if not already paired. As described above, the tester application may display a list of available truck testers and the user may select one truck tester to initiate pairing. The pairing may be accomplished via a BLUETOOTH or other wireless connection established between the wireless communication interface 620 of the truck tester 300 and a remote computing device on which the tester application is executing, as described above. In some examples, when a connection is established between the tester application and the truck tester 300, and a successful pairing occurs, the tester application may automatically set/confirm the date and time of the real time clock 614 on the truck tester 300 and display the dashboard screen (as shown, for example, in FIG. 8B). The user may navigate through the tester application to implement any or all of the advanced mode functionality described above.

In some examples, where the truck tester 300 is new or the user wishes to update one or more settings or configurations of the truck tester 300, the process 1000 optionally includes programming the truck tester 300 at operation 1006. Operation 1006 may include tasks such as changing the truck tester name, resetting passwords or other credentials, updating software or firmware on the truck tester, or any of many other programming tasks, as will be appreciated given the benefit of this disclosure.

At operation 1008, a testing session may be conducted. In some examples, the testing session at operation 1008 may include any or all of the operations 904-914 of process 900 described above. In some examples, at operation 1002, the truck tester automatically conducts a testing session as described above, including automatically performing operations 904, 906, and 912 and the tests associated therewith. In some examples, a user may, through the tester application, at operation 1010 control or direct one or more specific tests. For example, as described above, the truck tester can be controlled to perform particular tests of one or more selected sensors or other equipment on the tanker truck 100. Operation 1010 may be performed instead of, after, or concurrently with, operation 912 described above. As described above, in some examples, the tester application may display a list of available tests, and a user may select one or more tests to be performed. Testing instructions may then be sent to the microprocessor 602 via the communication link established by the wireless communication interface 620.

At operation 1012, the test results of the test session performed at operation 1008 may be displayed via one or more display screens accessed through the tester application, for example, as described above with reference to FIGS. 8D, 8E, and 8F. Operation 1012 may be performed concurrently with operations 908 and/or 914 described above. Furthermore, operation 1012 may be performed concurrently with operations 1008 and/or 1010. As described above, by connecting the truck tester 300 to the tester application, the user may be able to view a real-time display of sensor testing results on their computing device (operation 1012). Further, at operation 1010, the user can command certain specific channels and testing modes as needed. This can be particularly useful for users who may be working at some distance away from the truck tester 300 and need to see the real-time status of the display 308. The tester application, at operations 1010 and 1012 allows a user to see and react to an augmented version of the display 308.

Once the testing session at operation 1008 is complete (including any additional tests commanded at operation 1010), one or more data sets stored on the truck tester 300 (which may include test results from the current testing session and one or more prior testing sessions, as described above), can be selected for download at operation 1014. As described above, test data sets represent instances of testing performed by the truck tester 300. Each data set may include, for example, the date and time of the test, contents of the truck configuration data in the T.I.M., results of one or more tests performed during the active connection, and any error messages. At operation 1014, one or more of these data sets can be downloaded from the truck tester 300 to local storage on the computing device hosting the tester application.

In some examples, a user may only wish to access stored data sets, rather than perform current tanker truck testing. Accordingly, in such instances, the process 1000 can skip from operation 1004 directly to operation 1014.

At operation 1016, after selected data sets have been downloaded, the truck tester can be powered off, for example, by disconnecting it from the connection socket 106 as described above.

At operation 1018, information contained in the one or more downloaded data sets can be read back into the tester application, and one or more reports can be generated based on the data. Operation 1018 can be performed independently from connection with the truck tester 300, and therefore may be performed after the truck tester 300 has been powered down at operation 1016. The reports can be generated in any of numerous formats, including spreadsheets, text documents, formatted text documents, PDF files, etc. Further, the reports can be customized to include any selected data from one or more of the downloaded data sets. For example, multiple data sets corresponding to the testing of the same tanker truck at different times can be combined into a single report for that tanker truck. Similarly, multiple data sets from the same or different truck testers 300 corresponding to test sessions for various tanker trucks within a fleet can be combined to generate a fleet report. The reports can include information such as tanker truck ID, truck tester ID, test results, tanker truck information (e.g., number of compartments, type of fluids, etc.), time and date information, safety certification status and expiration date, and any other information that can be read into the tester application and that a user may wish to include in ay one or more reports.

### ADDITIONAL EXAMPLES

The following examples pertain to further embodiments, from which numerous permutations and configurations will be apparent.

Example 1 provides a dual-mode portable device for determining a status of a tanker truck safety and identification system, the device comprising: a plurality of contact pins configured to couple with corresponding contact pads on the tanker truck safety and identification system, a memory, a display, a wireless communication interface configured to support communication of data via at least one network protocol, and a microprocessor coupled to the plurality of contact pins, to the memory, and to the wireless communication interface. The microprocessor is configured to run a program to test one or more components of the tanker truck safety and identification system to determine the status of the tanker truck safety and identification system, in each of a first mode of operation and a second mode of operation of the dual-mode portable device, cause information regarding the status of the tanker truck safety and identification system to be displayed on the display and, upon completion of the program, store the information regarding the status of the tanker truck safety and identification in the memory, and in the second mode of operation of the dual-mode portable device, establish a connection with a remote device via the wireless communication interface, and transmit the information regarding the status of the tanker truck safety and identification to the remote device via the wireless communication interface.

Example 2 includes the dual-mode portable device of Example 1, wherein the wireless communication interface is a BLUETOOTH interface.

Example 3 includes the dual-mode portable device of Example 1, wherein the wireless communication interface is a WIFI interface.

Example 4 includes the dual-mode portable device of any one of Examples 1-3, wherein the one or more components of the tanker truck safety and identification system include at least one sensor coupled to a corresponding at least one of the contact pads, and wherein the program includes a diagnostic test of each at least one sensor.

Example 5 includes the dual-mode portable device of any one of Examples 1-4, wherein the one or more components of the tanker truck safety and identification system include a Truck Identification Module, and wherein the program includes a diagnostic test of the Truck Identification Module.

Example 6 includes the dual-mode portable device of any one of Examples 1-5, wherein, in the second mode of operation, the dual-mode portable device is further configured to receive, via the wireless communication interface, testing instructions from the remote device to control running of the program.

Example 7 includes the dual-mode portable device of any one of Examples 1-6, wherein the program includes a certification test of each of the one or more components of the tanker truck safety and identification system, the certification test being based on a safety standard for the tanker truck safety and identification system.

Example 8 includes the dual-mode portable device of Example 7, wherein the certification test includes a grounding test.

Example 9 includes the dual-mode portable device of one of Examples 7 or 8, wherein the one or more components includes one or more overfill sensors; and wherein the certification test includes a certification test of each at least one sensor.

Example 10 includes the dual-mode portable device of any one of Examples 1-9, wherein, in the second mode of operation, the microprocessor is configured to receive, via the wireless communication interface, one or more control instructions from the remote device, and modify a configuration or setting of the dual-mode portable device based on the control instructions.

Example 11 includes the dual-mode portable device of any one of Examples 1-10, provided in a housing configured to couple with a connection socket coupled to the tanker truck safety and identification and further comprising a power switch configured to detect connection of the dual-mode portable device with the connection socket and to allow operating power to be conveyed to the microprocessor upon detecting the connection with the socket, wherein, upon receiving the operating power, the microprocessor is configured to automatically run the program.

Example 12 includes the dual-mode portable device of Example 11, wherein the housing is a generally cylindrical handheld housing.

Example 13 includes the dual-mode portable device of any one of Examples 1-12, wherein, in each of the first and second modes of operation, the display is configured to display a status indicator for each at least one sensor of the tanker truck safety and identification.

Example 14 includes the dual-mode portable device of any one of Examples 1-13, further comprising a first intrinsically safe power supply controlled by the microprocessor and coupled to a first subset of the plurality of contact pins and configured to provide a first intrinsically safe voltage to each contact pin individually under control of the microprocessor, and a second intrinsically safe power supply controlled by the microprocessor and coupled to a contact pin not in the first subset of contact pins and configured to provide a second intrinsically safe voltage to the one contact pin under control of the microprocessor, wherein the first and second intrinsically safe voltages are on separate rails.

Example 15 includes the dual-mode portable device of any one of Examples 1-14, wherein the plurality of contact pins are spring-loaded pins.

Example 16 provides a portable device for determining a status of a tanker truck safety and identification system. The portable device comprises a plurality of contact pins configured to couple with corresponding contact pads on the tanker truck safety and identification system, at least one of the contact pads being coupled to at least one sensor of the tanker truck safety and identification system, a memory, a wireless communication interface configured to support communication of data via at least one network protocol, and a microprocessor coupled to the plurality of contact pins, to the memory, and to the wireless communication interface. The microprocessor is configured to establish a connection with a remote device via the wireless communication interface, run one or more programs to test each at least one sensor to determine the status of the tanker truck safety and identification system, during running of the one or more programs, transmit status indicators for each at least one sensor of the tanker truck safety and identification system to the remote device via the wireless communication interface, and store information regarding the status of the tanker truck safety and identification system in the memory upon completion of the one or more programs. The microprocessor is further configured to receive, via the wireless communication interface, a request from the remote device to transfer the information, and after receiving the request, transmit the information to the remote device via the wireless communication interface.

Example 17 includes the portable device of Example 16, wherein the microprocessor is further configured to receive, via the wireless communication interface, testing instructions from the remote device, and based on the testing instructions, run at least one program to test one or more components of the tanker truck safety and identification system.

Example 18 includes the portable device of Example 17, wherein the testing instructions identify at least one or a test to be performed or a particular one or more sensors of the tanker truck safety and identification system to be tested.

Example 19 includes the portable device of any one of Examples 16-18, further comprising a display, wherein the microprocessor is further configured to cause the status indicators to be displayed on the display.

Example 20 includes the portable device of any one of Examples 16-19, wherein the wireless communication interface is a BLUETOOTH interface.

Example 21 includes the portable device of any one of Examples 16-19, wherein the wireless communication interface is a WIFI interface.

Example 22 includes the portable device of any one of Examples 16-21, wherein the one or more programs includes a diagnostic test of each at least one sensor.

Example 23 includes the portable device of any one of Examples 16-22, wherein the one or more programs includes a certification test of each at least one sensor, the certification test being based on a safety standard for the tanker truck safety and identification system.

Example 24 includes the portable device of any one of Examples 16-23, wherein the microprocessor is further configured to receive, via the wireless communication interface, one or more control instructions from the remote device, and modify a configuration or setting of the portable device based on the control instructions.

Example 25 includes the portable device of any one of Examples 16-24, further comprising a first intrinsically safe power supply controlled by the microprocessor and coupled to a first subset of the plurality of contact pins and configured to provide a first intrinsically safe voltage to each pin individually under control of the microprocessor, and a second intrinsically safe power supply controlled by the microprocessor and coupled to a contact pin not in the first subset of pins and configured to provide a second intrinsically safe voltage to the one pin under control of the microprocessor, wherein the first and second intrinsically safe voltages are on separate rails.

Example 26 includes the portable device of any one of Examples 16-25, wherein the plurality of contact pins are spring-loaded pins.

Example 27 includes the portable device of any one of Examples 16-26 provided in a housing configured to couple with a connection socket coupled to the tanker truck safety and identification system, and further comprising a power switch configured to detect connection of the dual-mode portable device with the connection socket and to provide operating power to the microprocessor upon detecting the connection with the connection socket.

Example 28 includes the portable device of Example 27, wherein the housing is a generally cylindrical handheld housing.

Example 29 includes the portable device of any one of Examples 16-28, wherein the information regarding the status of the tanker truck safety and identification system includes results of the tests of each at least one sensor.

Example 30 provides a system for determining a status of a tanker truck safety and identification system, the system comprising a portable testing device configured to be coupled to one or more components of the tanker truck safety and identification system, and a computing device. The portable testing device comprises a plurality of contact pins configured to couple with corresponding contact pads on the tanker truck safety and identification system, a memory, a wireless communication interface configured to support communication of data via at least one network protocol, and a microprocessor coupled to the plurality of contact pins, to the memory, and to the wireless communication interface. The microprocessor is configured to run one or more programs to test the one or more components to determine the status of the tanker truck safety and identification system and to store information regarding the status of the tanker truck safety and identification system in the memory. The computing device is configured to be communicatively coupled to the portable testing device via the wireless communication link established with the portable testing device via the wireless communication interface. The computing device is configured to run a control program to display, on the computing device and during running of the at least one program, results of the tests of the one or more components, and after completion of the at least one program, initiate transfer of the information regarding the status of the tanker truck safety and identification system from the memory of the portable testing device to the computing device.

Example 31 includes the system of Example 30, wherein the computing device is further configured to display results of one or more prior sets of tests of the one or more components.

Example 32 includes the system of one of Examples 30 or 31, wherein the one or more components include at least one sensor; wherein the contact pads are individually coupled to respective ones of the at least one sensor of the tanker truck safety and identification system; and wherein the one or more programs includes a diagnostic test of each at least one sensor.

Example 33 includes the system of Example 32, wherein the one or more programs includes a certification test of each at least one sensor, the certification test being based on a safety standard for the tanker truck safety and identification system.

Example 34 includes the system of any one of Examples 30-33, wherein the control program is further configured to direct the microprocessor of the portable testing device to run at least one of the one or more programs to test each of the one or more components.

Example 35 is a computer program product including one or more non-transitory machine-readable mediums encoded with instructions that when executed by one or more processors cause a process to be carried out for determining a status of a tanker truck safety and identification system. The process comprises identifying a portable testing device coupled to at least one component of a tanker truck safety and identification system under test, establishing a wireless connection between a remote computing device and the portable testing device, controlling the portable testing device to run one or more programs to test each at least one component to determine the status of the tanker truck safety and identification system, and during running of the one or more programs, displaying results of the tests of each at least one component at the remote computing device. The process further comprises allowing selection of data regarding the status of the tanker truck safety and identification system for download from the portable testing device, the data including at least some of the results of the tests of each at least one component, and initiating the download of the data, via the wireless connection, from the portable testing device to the remote computing device.

Example 36 includes the computer program product of Example 35, wherein the at least one component includes at least one sensor.

Example 37 includes the computer program product of Example 36, wherein the one or more programs includes a diagnostic test of each at least one sensor.

Example 38 includes the computer program product of one of Examples 36 or 37, wherein the one or more programs includes a certification test of each at least one sensor, the certification test being based on a safety standard for the tanker truck safety and identification system.

Example 39 includes the computer program product of any one of Examples 35-38, wherein the process further comprises displaying results of at least one prior set of tests of each at least one component.

Example 40 includes the computer program product of any one of Examples 36-39, wherein displaying the results of the tests of each at least one sensor includes displaying status indicators for each at least one sensor.

Example 41 includes the computer program product of any one of Examples 35-40, wherein the process further comprises modifying at least one configuration or setting of the portable testing device via control instructions transmitted to the portable testing device over the wireless connection.

Having described above several aspects of at least one embodiment, it is to be appreciated various alterations, modifications, and improvements will readily occur to those skilled in the art. Such alterations, modifications, and improvements are intended to be part of this disclosure. Accordingly, the foregoing description and drawings of various embodiments are presented by way of example only. These examples are not intended to be exhaustive or to limit implementation to the precise forms disclosed. The methods and apparatuses are capable of implementation in other embodiments and of being practiced or of being carried out in various ways. In addition, the phraseology and terminology used herein is for the purpose of description and should not be regarded as limiting. Any references to examples, components, elements, or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including”, “comprising”, “having”, “containing”, “involving”, and variations thereof is meant to encompass the items listed thereafter and equivalents thereof as well as additional items. References to “or” can be construed as inclusive so that any terms described using “or” can indicate any of a single, more than one, and all of the described terms.

1. A dual-mode portable device for determining a status of a tanker truck safety and identification system, the device comprising:
a plurality of contact pins configured to couple with corresponding contact pads on the tanker truck safety and identification system;
a memory;
a display;
a wireless communication interface configured to support communication of data via at least one network protocol; and
a microprocessor coupled to the plurality of contact pins, to the memory, and to the wireless communication interface, the microprocessor configured to
run a program to test one or more components of the tanker truck safety and identification system to determine the status of the tanker truck safety and identification system,
in each of a first mode of operation and a second mode of operation of the dual-mode portable device, cause information regarding the status of the tanker truck safety and identification system to be displayed on the display and, upon completion of the program, store the information regarding the status of the tanker truck safety and identification in the memory, and
in the second mode of operation of the dual-mode portable device, establish a connection with a remote device via the wireless communication interface, and transmit the information regarding the status of the tanker truck safety and identification to the remote device via the wireless communication interface.

2. The dual-mode portable device of claim 1, wherein the one or more components of the tanker truck safety and identification system include at least one sensor coupled to a corresponding at least one of the contact pads; and
wherein the program includes a diagnostic test of each at least one sensor.

3. The dual-mode portable device of claim 1, wherein, in the second mode of operation, the dual-mode portable device is further configured to receive, via the wireless communication interface, testing instructions from the remote device to control running of the program.

4. The dual-mode portable device of claim 1, wherein the program includes a certification test of each of the one or more components of the tanker truck safety and identification system, the certification test being based on a safety standard for the tanker truck safety and identification system.

5. The dual-mode portable device of claim 1, wherein, in the second mode of operation, the microprocessor is configured to:
receive, via the wireless communication interface, one or more control instructions from the remote device; and
modify a configuration or setting of the dual-mode portable device based on the control instructions.

6. The dual-mode portable device of claim 1, provided in a housing configured to couple with a connection socket coupled to the tanker truck safety and identification and further comprising:
a power switch configured to detect connection of the dual-mode portable device with the connection socket and to allow operating power to be conveyed to the microprocessor upon detecting the connection with the connection socket;
wherein, upon receiving the operating power, the microprocessor is configured to automatically run the program.

7. The dual-mode portable device of claim 1, wherein, in each of the first and second modes of operation, the display is configured to display a status indicator for each at least one sensor of the tanker truck safety and identification.

8. The dual-mode portable device of claim 1, further comprising:
a first intrinsically safe power supply controlled by the microprocessor and coupled to a first subset of the plurality of contact pins and configured to provide a first intrinsically safe voltage to each contact pin individually under control of the microprocessor; and
a second intrinsically safe power supply controlled by the microprocessor and coupled to a contact pin not in the first subset of contact pins and configured to provide a second intrinsically safe voltage to the one contact pin under control of the microprocessor, wherein the first and second intrinsically safe voltages are on separate rails.

9. The dual-mode portable device of claim 1, wherein the wireless communication interface is a BLUETOOTH interface.

10. A portable device for determining a status of a tanker truck safety and identification system, the portable device comprising:
a plurality of contact pins configured to couple with corresponding contact pads on the tanker truck safety and identification, at least one of the contact pads being coupled to at least one sensor of the tanker truck safety and identification;
a memory;
a wireless communication interface configured to support communication of data via at least one network protocol; and
a microprocessor coupled to the plurality of contact pins, to the memory, and to the wireless communication interface, the microprocessor configured to
establish a connection with a remote device via the wireless communication interface,
run one or more programs to test each at least one sensor to determine the status of the tanker truck safety and identification system,
during running of the one or more programs, transmit status indicators for each at least one sensor of the tanker truck safety and identification system to the remote device via the wireless communication interface,
store information regarding the status of the tanker truck safety and identification system in the memory upon completion of the one or more programs,
receive, via the wireless communication interface, a request from the remote device to transfer the information, and
after receiving the request, transmit the information to the remote device via the wireless communication interface.

11. The portable device of claim 10, wherein the microprocessor is further configured to:
receive, via the wireless communication interface, testing instructions from the remote device; and
based on the testing instructions, run at least one program to test one or more components of the tanker truck safety and identification system.

12. The portable device of claim 10, further comprising a display; wherein the microprocessor is further configured to cause the status indicators to be displayed on the display.

13. The portable device of claim 10, wherein the one or more programs includes a diagnostic test of each at least one sensor.

14. The portable device of claim 10, wherein the one or more programs includes a certification test of each at least one sensor, the certification test being based on a safety standard for the tanker truck safety and identification system.

15. The portable device of claim 10, wherein the microprocessor is further configured to:
receive, via the wireless communication interface, one or more control instructions from the remote device; and
modify a configuration or setting of the portable device based on the control instructions.

16. The portable device of claim 10, provided in a housing configured to couple with a connection socket coupled to the tanker truck safety and identification system and further comprising:
a power switch configured to detect connection of the dual-mode portable device with the connection socket and to provide operating power to the microprocessor upon detecting the connection with the connection socket.

17. The portable device of claim 10, wherein the information regarding the status of the tanker truck safety and identification system includes results of the tests of each at least one sensor.

18. A system for determining a status of a tanker truck safety and identification system, the system comprising:
a portable testing device configured to be coupled to one or more components of the tanker truck safety and identification system, the portable testing device comprising
a plurality of contact pins configured to couple with corresponding contact pads on the tanker truck safety and identification,
a memory,
a wireless communication interface configured to support communication of data via at least one network protocol, and
a microprocessor coupled to the plurality of contact pins, to the memory, and to the wireless communication interface, the microprocessor configured to run one or more programs to test the one or more components to determine the status of the tanker truck safety and identification system and to store information regarding the status of the tanker truck safety and identification system in the memory; and
a computing device configured to be communicatively coupled to the portable testing device via the wireless communication link established with the portable testing device via the wireless communication interface, the computing device configured to run a control program to
display, on the computing device and during running of the one or more programs, results of the tests of the one or more components, and
after completion of the one or more programs, initiate transfer of the information regarding the status of the tanker truck safety and identification system from the memory of the portable testing device to the computing device.

19. The system of claim 18, wherein the computing device is further configured to display results of one or more prior sets of tests of the one or more components.

20. The system of claim 18, wherein the one or more components include at least one sensor; wherein the contact pads are individually coupled to respective ones of the at least one sensor of the tanker truck safety and identification system; and wherein the one or more programs includes a diagnostic test of each at least one sensor.

21. The system of claim 20, wherein the one or more programs includes a certification test of each at least one sensor, the certification test being based on a safety standard for the tanker truck safety and identification.
